(19) United States
(12) Patent Application Publication
(10) Pub. No.: US 2008/0166203 A1
(43) Pub. Date: Jul. 10, 2008

(54) PLASTIC OVERMOLDED SCREW

(75) Inventors: Matthew John Reynolds, Penetanguishene (CA); Andrew Reginald McIntyre, Midland (CA)

Correspondence Address: BROOKS KUSHMAN P.C., 1000 TOWN CENTER, TWENTY-SECOND FLOOR, SOUTHFIELD, MI, 48075, US

(73) Assignee: M & C CORPORATION, Sterling Heights, MI (US)

(21) Appl. No.: 11/972,220

(22) Filed: Jan. 10, 2008

Related U.S. Application Data
(60) Provisional application No. 60/879,695, filed on Jan. 10, 2007.

(51) Int. Cl. F16B 23/00; F16B 37/14; F16B 33/00; B29C 45/14

(52) U.S. Cl. 411/377; 264/274

(57) ABSTRACT

A two-piece fastener, for example a bumper screw, includes a fastener and an overmolded resilient portion configured to avoid contact with a fastening tool.

### CROSS-REFERENCE TO RELATED APPLICATIONS

This application claims the benefit of U.S. provisional application Ser. No. 60/879,695, filed Jan. 10, 2007, the disclosure of which is hereby incorporated in its entirety.

### BACKGROUND OF THE INVENTION

1. Field of the Invention

The invention relates to overmolded fasteners that act as hard stops in automotive body structures.

2. Background Art

Screws are often used in mechanisms to create an adjustable hard stop between one part of a mechanism and another. When the one part of the mechanism hits the screw, a contact sound is made. In a vehicle, these contact noises need to be eliminated. For example, a vehicle closure hinge mechanism may permit the closure's position with respect to an adjacent body panel to be aligned at a height for proper fit and finish. Some previously known bumper screws have tried to put plastic on the top of the screw head. The plastic should be attached to the screw head so that it will not fall off during the life of the vehicle. The plastic should be soft because hard plastics will not eliminate the contact sound. If the whole head of the screw were soft plastic, a driver would strip or damage the head during installation.

A previously known bumper screw employs a typical steel bolt having a cavity in the enlarged head to receive a correspondingly shaped driver or tool. A plastic coating is then injection molded onto the screw at the head, but is not applied above the tool receiving cavity in the head. This substantially reduces the area and the integrity of the plastic cover on the head. Accordingly, repeated impacts with the plastic layer on the head must be absorbed by a smaller mass of plastic material and induces deformation that can tend to fracture or deteriorate the plastic coating during the working life of the bumper screw.

Another known bumper screw includes an enlarged head having a shaped exterior surface, such as a hexagonal perimeter, which is adapted to be engaged by a tool for driving the screw. A plastic insert is molded into a cavity formed in the top surface of the screw head. The recess in the head is back cut so that the molding of plastic material in the cavity becomes mechanically fixed to the top of the screw when the plastic is cured. However, such modification of the screw head and body requires technical machining or fabrication processes that substantially complicate manufacture before the molding of the plastic insert can be accomplished.

### SUMMARY

The present invention overcomes the above mentioned disadvantages by providing a method and a product produced by the method for plastic molding, over the screw head, for example, by injection molding with a fastener insert. The resulting product avoids exposing the plastic body to abusive or detrimental forces by assuring the force is applied to the fastener, often made of metal, in connection with turning or engaging the screw during fastening. The result may be accomplished without interior, recessed machining of the metal screw body before injection molding to reinforce the plastic material. For example, on a hex head bolt, or similar polygonally or otherwise shaped screw head, the side walls of the screw head intermediate the tool engagement points of the hex head may be notched to receive plastic during an insert molding operation. Preferably, in one embodiment, the areas intermediate the points of the apexes on the head of a fastener may be concavely grooved by machining, forming or grinding. This and other embodiments may leave portions of the contact surfaces of the screw head sidewalls near to the points or apexes exposed for control with the contact surfaces of a driver socket or wrench, without directly contacting or applying force to a portion of the plastic overmolding.

In a preferred embodiment, substantial portions of the six points of the hex are exposed. The injection molded plastic covers the top and fills notches in the screw head. Since the hex points of this example are exposed, the driver socket only makes contact with the metal head portions, and the screw may be driven no matter how soft or resilient the covering may be. Preferably, while portions of the screw head adjacent the six points may be exposed, other portions such as rounded edges near the top of the screw head may be covered during molding of the plastic, to maximize the size of the plastic material molded as a bumper. As a result, the invention provides unloading of the plastic portion, even during installation of the compound fastener, by limiting contact with contact surfaces of the tool.

Preferably, the injection molding permits flow of plastic to extend also along the bottom of the screw head to ensure that the plastic body will mechanically resist displacement from, and not separate from, the metal body of the screw. Accordingly, embodiments of the present invention permit softer plastic than has been employed in previously known bumper screws in which a small area of the plastic material must be used to hold the plastic in fixed mechanical engagement with the metal screw body. In addition, a resilient plastic material may be more robustly secured to the screw head when the molded plastic encapsulates around the top, sides and bottom of the metal head, as illustrated in a preferred embodiment. As a result, the method and the product provide unloading of the molded plastic portion by wrapping or contacting numerous surfaces of the metal insert portion positioning it in the mold.

The invention may be used on any externally shaped head, for example hex, octagonal, square, pentagonal and other shapes of externally driven fasteners. Since externally engaged and driven fasteners are more common, assembly tooling can be shared and reused, a substantial cost savings by the manufacturer of the plastic overmolded screw product. The internal steel often used to form the screw head and body allows use of a magnetic driver socket, even if the top surface of the screw head is fully covered by a plastic layer.

### BRIEF DESCRIPTION OF THE DRAWINGS

The present invention will be better understood by reference to the accompanying drawing in which like reference characters refer to like parts throughout the views, and in which

FIG. 1 is a perspective view of a product embodiment made by a process according to the present invention;

FIG. 2 is a plan view of a fastener insert for molding in a process according to the invention;

FIG. 3 is a plan view of a product embodiment shown in FIG. 1 positioned in a mold cavity to form a product according to the present invention;

FIG. 4 is a side view of the product embodiment of FIGS. 1 and 3; and

FIG. 5 is a side view of a modified insert without chamfer for exposing additional surface area of the fastener through openings in the overmolded layer.

### DETAILED DESCRIPTION OF A PREFERRED EMBODIMENT

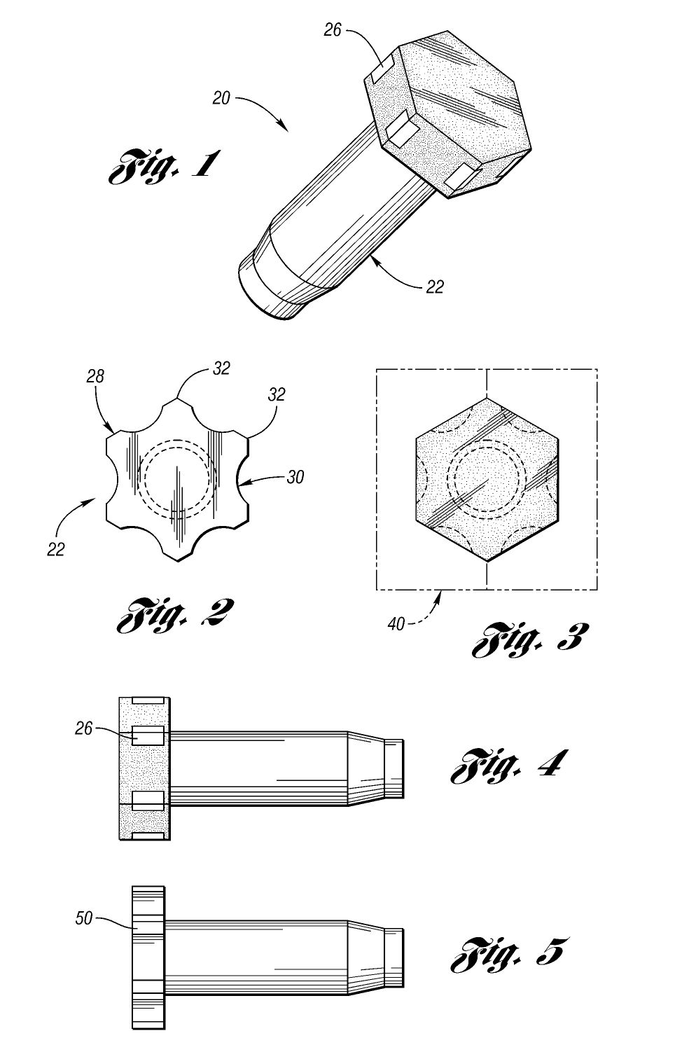

Referring first to FIG. 1, a product 20 is there shown comprising a fastener part 22 carries an overmolded layer 24. The fastener part 22 may be formed in the manner of many previously known fasteners adapted to be engaged by tools for installing a fastener in a part. For example, screws with hex heads are very commonly available and may be used as the fastener inserts. Nevertheless, it is to be understood that material employed in forming the fastener part 22 is not limited to metal. Similarly, the overmolded portion 24 may be a substantially softer material as may be desirable to provide a cushioning surface and intended to perform as a bumper screw. Nonetheless, it is to be understood that the overmolded material is not limited to any particular performance characteristics or bumper applications, depending only upon the end use to the product as made. As a result, it will be understood to those of ordinary skill in the art that the overmolded portion 24 and the fastener 22 may have substantially different force resisting characteristics depending upon their intended use. For the purpose of forming bumper screws, it may be appreciated that substantially softer and more pliable overmolded material 24 may be combined with hardier, robust fasteners without departing from the present invention. Nevertheless, the present invention provides greater selection of materials in forming an overmolded surface on bumper screws than was previously possible when previous fabrication techniques exposed the overmolded material to the forces of tool engagement that can destroy the overmolded portion subjected to such forces.

In FIG. 2, notches 30 formed in each side of a hexagonal head 28 screw head intermediate the points or corners 32 of the hex head 28, although the number of sides on the screw head to be externally driven is not limited according to the present invention. The corners 30 form working surfaces engageable by a fastening tool, such as a socket or wrench. The notches may be formed during the fabrication of the metal body itself. Alternatively, commonly available headed screws may be subjected to a simple machining, cutting or other shaping operation along its external surface to remove some material intermediate the pointed areas of the head.

As shown in FIG. 3, the fastener part as shown in FIG. 2 is then inserted into a mold 40 so that the external perimeter shape of the head 28 generally conforms with the original size of the head. Portions of the head 28 may be chamfered, or portions of the mold wall relieved, so that molding material may form an upper layer, a lower layer, and intermediate portions of the plastic material filling the notches 30.

As best shown in FIGS. 3-5, the mold parts may expose a limited area, for example by a tight fit portion, adjacent points or corners 32 of the screw head 28 so that the material of the screw body remains exposed at limited surface portions 26 adjacent the points 32 after plastic molding the portion 24. As a result, a driver socket engaging the overmolded bumper screw acts only against metal surfaces, while the plastic material remains unaffected by application of the tool.

As a result, the present invention provides numerous embodiments of down stop or bumper screw with a molded head in which a plastic covering reduces noise as desired but with enhanced integrity even during tool contact and installation. Moreover, the embodiments are capable of longer life than previously known molded bumper screws. Limiting contact or exposure of the covering minimizes abuse or displacement when applying installation tools. Moreover, the integrity of the plastic material and its continuity over numerous surfaces of the screw head to limit exposure to loads that wear or distort the molded portion to thereby provide substantially longer wear life or greater surface area to absorb shocks than previously known bumper screws. As shown in FIG. 5, the exposed areas 26 may be expanded as to desired to simplify fabrication or otherwise reduce the overmolded material used in each part.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention as defined in the claims.

What is claimed is:

1. A method for molding plastic bumper on a screw body having an enlarged screw head periphery comprises
providing recesses in the screw head periphery intermediate tool engaging points of a fastener insert, and
insert molding plastic material adjacent a top surface, the recesses and a bottom of the screw head.

2. The invention as described in claim 1 wherein said enlarged head includes chamfers and wherein said insert molding includes overmolding said chamfers.

3. The invention as described in claim 2 and further comprising limiting exposure of said head through said plastic material.

4. The invention as described in claim 3 wherein said limiting is adjacent working surfaces of said head.

5. The invention as described in claim 4 wherein said working surfaces are corners of said head.

6. A bumper screw comprising
a screw body with a head having a peripheral wall with a plurality of tool engaging surfaces,
a notch formed intermediate adjacent tool engaging surfaces, and
a resilient material molded over the top, in the notch and under the head, and at least one surface portion of said tool engaging surfaces exposed through said resilient material.

7. The invention as described in claim 5 wherein said tool engaging surface is surrounded by said resilient material.

8. The invention as described in claim 5 wherein said tool engaging surfaces are corners.
